(19) United States
(12) Patent Application Publication
(10) Pub. No.: US 2018/0105071 A1
(43) Pub. Date: Apr. 19, 2018

(54) METHOD FOR PRE-ADJUSTING VEHICLE SEATS

(71) Applicant: Adient Luxembourg Holding S.à.r.l., Luxembourg (LU)

(72) Inventor: Wei LANGE-MAO, Hagen (DE)

(21) Appl. No.: 15/566,866

(22) PCT Filed: Apr. 11, 2016
(86) PCT No.: PCT/EP2016/057903

§ 371 Date: Oct. 16, 2017

(30) Foreign Application Priority Data
Apr. 15, 2015 (DE) 10 2015 206 787.4

(51) Int. Cl. B60N 2/02

(52) U.S. Cl. CPC B60N 2/0244; B60N 2/0228; B60N 2002/0268; B60N 2/0232; B60N 2/0296

(57) ABSTRACT

A method for pre-adjusting a vehicle seat (1) for a passenger (2) using the vehicle seat (1) includes providing the vehicle seat (1) in a first vehicle seat configuration. A communication device (4) is integrated into a vehicle (6) and is activated. After activation, information relating to the passenger (2) is input into the communication device (4). The input information is then transmitted to a control unit (5). A second vehicle seat configuration is ascertained on the basis of the transmitted information. The vehicle seat (1) is then automatically converted from the first vehicle seat configuration to the second vehicle seat configuration.

### CROSS REFERENCE TO RELATED APPLICATIONS

This application is a United States National Phase Application of International Application PCT/EP2016/057903, filed Apr. 11, 2016, and claims the benefit of priority under 35 U.S.C. § 119 of German Application 10 2015 206 787.4, filed Apr. 15, 2015, the entire contents of which are incorporated herein by reference.

### FIELD OF THE INVENTION

The present invention relates to a method for pre-adjusting vehicle seats.

### BACKGROUND OF THE INVENTION

Many vehicle passengers do not set the correct vehicle seat configuration when using their vehicle seat. Particularly on longer journeys, the unsuitable choice of the vehicle seat configuration can result in back pain and heavy legs. In the event of an accident, the risk further exists that an incorrectly adjusted vehicle seat protects the passenger less than a correctly adjusted vehicle seat. This relates, in particular, to components of the vehicle seat through the adjustment of which no substantial increase in comfort is normally achieved and which are therefore seldom adjusted regularly by the passenger. One example of a component of this type is a headrest, which is intended to prevent the hyperextension of the cervical spine of the passenger in the event of an accident. Is therefore desirable for the vehicle seat to assume independently an individually adapted and, as far as possible, optimum vehicle seat configuration when the passenger is about to use the vehicle seat. In particular, a pre-adjustment of this type is desirable if the vehicle seat is regularly used by different passengers, as in the case, for example, of family cars, pool vehicles of a company, rental cars or car-sharing vehicles.

The prior art knows, for example from document WO 2012/048100 A2, of a seat adjustment method based on a set of information which must be determined laboriously and must be processed by means of complicated algorithms. For example, said document proposes an overlay of a measurement template with an image of the user in order to acquire the set of information.

### SUMMARY OF THE INVENTION

An object of the present invention is to provide a method by means of which the passenger is provided with a pre-adjustment of his vehicle seat without the need for laborious measuring methods or additional equipment.

The present invention achieves the object through a method for pre-adjusting a vehicle seat for a passenger using the vehicle seat, wherein, in a first method step, the vehicle seat is provided in a first vehicle seat configuration, wherein, in a second method step, a communication device integrated into a vehicle, in particular an infotainment system, is activated, wherein, in a third method step, information relating to the passenger is entered into the communication device, wherein, in a fourth method step, the entered information is transmitted to a control unit, wherein, in a fifth method step, depending on the transmitted information, a second vehicle seat configuration is determined, wherein, in a sixth method step, the vehicle seat is moved, in particular automatically, from the first vehicle seat configuration into the second vehicle seat configuration.

Compared with the prior art, the present invention offers the advantage that laborious and sometimes error-prone measuring methods, for example by means of a camera, or additional equipment, such as Smartphones or tablets, are no longer required. Instead, the passenger or a further passenger simply enters the information describing the passenger into the communication device integrated into the vehicle and the vehicle seat is moved into the second vehicle seat configuration.

In particular, an infotainment system is used, for example an infotainment system installed in the dashboard or a central console or mounted on a rear side of the vehicle seat. However, it is also conceivable for the communication device to be designed as a head-up-display or to be disposed on a windscreen. According to the invention, it is conceivable for the passenger or a further passenger to be the driver of the vehicle. In order to move the vehicle seat into the second vehicle seat configuration, in particular, an adjuster controllable by the control unit or a plurality of adjusters are provided, with which the entire vehicle seat can be adjusted as a unit and/or with which the position or alignment of individual vehicle seat components can be adjusted. The control unit is connected wirelessly and/or via a cable to the adjuster or adjusters. Motor-driven adjusters are preferably used. It is provided, in particular, in the sixth method step, that a backrest of the vehicle seat is pivoted, a height adjustment of a seat area is modified, a tilt of the seat area and/or a distance between the vehicle seat and a steering wheel of the vehicle is modified. It is also conceivable for the depth of the seat area to be modified. According to the invention, it is also conceivable, in the sixth method step, for the headrest to be moved into a position adapted to the passenger, wherein the headrest is, for example, pivotable around a pivot axis and is height-adjustable relative to the seat area. The vehicle seat preferably comprises a plurality of motors to implement the pre-adjustment of the vehicle seat.

According to a further embodiment of the present invention, it is provided, in a seventh method step, that the vehicle seat is moved manually or via further inputs into the communication device from the second vehicle seat configuration into a third vehicle seat configuration. As a result, the passenger can advantageously move the vehicle seat into a vehicle seat configuration corresponding to his individual comfort requirements. In particular, it is provided for this purpose that the adjusters enable both manual and motorized operation.

According to a further embodiment of the present invention, it is provided that the third vehicle seat configuration, preferably together with an ID, is stored in a storage unit, in particular in a memory for vehicle seat configurations. The adjustment of the vehicle seat for the passenger can thereby be advantageously reproduced when the passenger once more wishes to use the vehicle seat. It is also conceivable for the stored vehicle seat position to be stored in an external memory unit, for example in a customer account of a car rental company. Here, it is provided that the communication device communicates with the external memory when the ID is entered into the communication device integrated into the vehicle. It is also conceivable for a third vehicle seat configuration to be stored for a passenger and for the stored third vehicle seat configuration to be proposed to a further passenger as an alternative to the second vehicle seat configuration if the information entered into the communication device for the passenger and the further passenger resemble or match one another. The passenger or the further passenger is thereby advantageously supported in the choice of the adjustment for the vehicle seat.

According to a further embodiment of the present invention, it is provided, in the third method step, that a single information element, in particular a single numerical value describing the information, is entered into the communication device. It has become evident that a single information element, for example the body height of the passenger or a seat height of the passenger, suffices to determine a second vehicle seat configuration adapted to the passenger.

According to a further embodiment of the present invention, it is provided that an algorithm based on simulations and/or on empirical values is used to determine the second vehicle seat configuration in the fifth method step. The algorithm preferably uses empirical values which have been obtained in advance from experiments or studies and/or simulations. In particular, the pre-adjustment is performed on the basis of simulations and from examinations of test persons. It is also conceivable for the algorithm to be refreshed or at least partially renewed in the form of an update after a certain time. Only the information relating to the body height of the passenger is preferably required by the algorithm in order to define the second vehicle seat configuration. It is provided, in particular, that a vehicle type, the environment of the vehicle seat, a general sitting position of passengers and/or the gender of the passenger is/are also taken into account in the empirical values.

According to a further embodiment of the present invention, it is provided that further information describing the vehicle seat or its environment is used along with the information describing the passenger in the fifth method step for determining the second vehicle seat configuration. Additional aspects which relate, for example, to the safety of the passenger can also be taken into account without great effort on the part of the passenger. The further information relating to the vehicle and its environment comprises, for example, a distance between the vehicle seat and a steering wheel of the vehicle, a distance between the vehicle seat and a front seat in the vehicle, a position of the steering wheel and/or a position of a head-up display. It is furthermore conceivable for a preselection to be made in an intermediate step by means of a pre-categorization. For example, a gender applicable to the passenger, a weight class, a preferred driving style or the total number of persons in the vehicle is selected in each case from a list provided by the communication device. A specific algorithm, the only variable of which is the information entered as a numerical value, in particular the body height of the passenger, is preferably defined depending on the chosen preselection.

According to a further embodiment of the present invention, when the information describing the passenger is entered once more, it is provided in a ninth method step that—the vehicle seat is moved from the first vehicle seat configuration into the third vehicle seat configuration, and/or—the passenger is offered a selection between the second vehicle seat configuration and the third vehicle seat configuration. As a result, the pre-adjustment is further simplified for the passenger, since he no longer needs to make a fine adjustment.

According to a further embodiment of the present invention, it is provided that the passenger is informed if a tolerance threshold for a deviation from the second vehicle seat configuration is exceeded. For example, an indication by the communication device appears or a warning signal sounds. It can thereby be ensured that a safety risk due to a vehicle component ignored by the driver in the seventh method step or incorrectly adjusted can be avoided. A situation can be envisaged in which, for example, the seat area height has been adjusted to such an extent that the headrest can no longer counteract a hyperextension of the cervical spine of the passenger as intended in the event of an accident.

According to a further embodiment of the present invention, it is provided, in the movement from the second vehicle seat configuration into the third vehicle seat configuration, that a modification of partial areas of the vehicle seat, i.e. of specific vehicle seat components, is not allowed.

According to a further embodiment of the present invention, it is provided, in a tenth method step, that a further component of the vehicle assumes a first component configuration or is moved into the first component configuration on the basis of the information entered into the communication device or the second or third vehicle configuration, wherein the adjustment of the further components is similarly individually adjustable by the passenger in an eleventh method step. An automatic and independent alignment, for example, of the steering wheel, a wing mirror and/or the central rearview mirror can be performed in the tenth and/or eleventh method step.

According to a further embodiment of the present invention, it is provided that an electrical adjustment of the vehicle seat taking place in the sixth method step can be stopped or at least paused or interrupted by means of an emergency shutdown functionality. The safety level can thereby be increased in respect of a possible incorrect operation (e.g. by children).

According to a further embodiment of the present invention, it is provided that it is necessary for the passenger to be seated in the vehicle for the input into the communication device.

According to a further embodiment of the present invention, it is provided that the information describing the passenger is information relating to the body height of the passenger or relating to the body proportions of the passenger or relating to the preferred sitting position type, in particular corresponds to the body height of the passenger or the trunk length of the passenger or a preferred comfort position or a preferred sport position. Here, in the context of the present invention, in the case of a passenger seated upright on a (normally flat) seat area, the term trunk length of the passenger is understood to mean the measurement from the seat area up to the top edge of the head of the passenger. Alternatively, information indicating whether the passenger looks tiny or huge or normal-sized when seated can furthermore also be used according to the invention. A person who looks huge when seated is typically understood to refer to the situation in which a person has a comparatively large (or long) upper body (from the head to the hip) and a comparatively small (or short) legs, whereas a person who looks tiny when seated is typically understood to refer to the situation in which a person has a comparatively small (or short) upper body and comparatively large (or long) legs. Furthermore, in the context of the present invention, the preferred sitting position type is understood to mean whether the passenger tends to prefer to assume a more upright and/or lower sitting position (sport position) or rather a less upright and/or higher sitting position (comfort position). Alternatives to the use of the body height or information relating to the body height of the passenger exist in the use of the weight of the passenger and/or the gender of the passenger and/or the age of the passenger.

According to a further embodiment of the present invention, it is provided that the seat and/or the environment of the vehicle is/are monitored by means of a sensor unit. For example, it is conceivable for the vehicle seat to be moved into a protective position if a hazardous situation for the passenger is detected by means of the sensor element. In particular, it is conceivable for the headrest position to be modified in such a situation.

A movement of the vehicle seat from the second vehicle seat configuration into the third vehicle seat configuration is preferably controlled and/or adjusted with a weight transfer of the passenger during a predefined time window. Separate operating elements for controlling the vehicle seat configuration are therefore superfluous and can be eliminated. The passenger can furthermore simply and intuitively readjust the vehicle seat configuration.

According to a further embodiment of the present invention, it is provided that adaptive materials are integrated into the vehicle seat. The integrated, adaptive materials comprise, in particular, electrical and/or magnetorheological fluids and/or electrical and/or magnetorheological polymers. Mechanical properties of the vehicle seat are reversibly modifiable by means of an electric or magnetic field. The mechanical properties of the adaptive material are modifiable by means of the activation or deactivation of the electric or magnetic field in such a way that is possible to switch between a first material state in which a modification of the vehicle seat configuration of the vehicle seat is enabled, and a second material state in which the seat position of the vehicle seat is fixed. The adaptive materials integrated into the vehicle seat enable a particularly flexible adaptation of the seat position which is comfortably definable by means of the activation or deactivation of the electric or magnetic field.

A further subject-matter of the present invention is a device for a method for pre-adjusting a vehicle seat for a passenger using the vehicle seat, preferably using a method according to the invention, wherein the device has a communication device integrated into a vehicle for an input of information describing the passenger, a control unit for receiving and further processing the information and an adjuster controllable by the control unit to adjust a vehicle seat component.

A pre-adjustment of the vehicle seat can be performed in a simple manner compared with the prior art without the passenger having to use laborious and sometimes error-prone measuring methods or having to carry additional equipment, such as a Smartphone or tablet, with him at all times.

According to a further embodiment of the present invention, it is provided that the device has a storage unit for storing vehicle seat configurations. A third vehicle seat configuration which has been achieved by a fine adjustment carried out manually by the passenger can advantageously be stored and reused at a later time.

Further details, features and advantages of the invention can be found in the drawings, and also in the following description of preferred embodiments with reference to the drawings. The drawings merely illustrate example embodiments of the invention which do not restrict the inventive concept. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a view showing a method for pre-adjusting a vehicle seat for a passenger using the vehicle seat according to one example embodiment of the present invention.

### DESCRIPTION OF THE PREFERRED EMBODIMENTS

Referring to the drawings, same parts are always denoted with the same reference numbers and are therefore normally also specified or mentioned in each case once only.

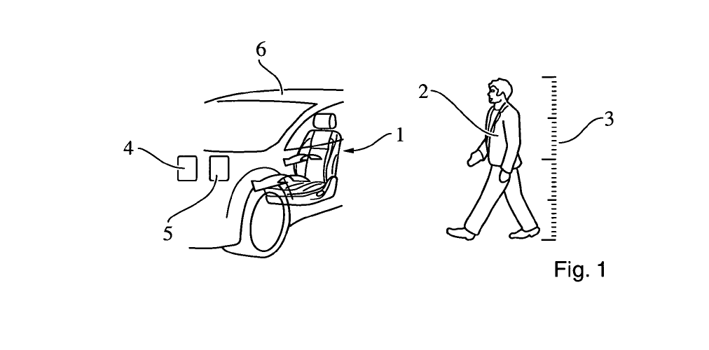

FIG. 1 shows a method for pre-adjusting a vehicle seat 1 for a passenger 2 using the vehicle seat, for example a driver or passenger, according to one example embodiment of the present invention. The vehicle seat 1 of a vehicle 6 is preferably supplied to the passenger 2 in a first method step in a first vehicle seat configuration. For example, the vehicle seat is left by a previous user in the first vehicle seat configuration which, in particular, differs from a comfortable vehicle seat configuration for the passenger 2. In order to pre-adjust the vehicle seat 1, it is then provided that the passenger 2 enters the vehicle 6 in a second method step, sits on the vehicle seat 1 and activates a communication device 4, for example an infotainment system or a program stored on the infotainment system. It is conceivable for the communication device 4 to be activated automatically by a door opening of the vehicle 6, a turning of the ignition key or by means of a weight sensor integrated into the vehicle seat 1, or indirectly by the passenger 2. It is then provided in a third method step that a body height 3 of the passenger 2 is entered, for example, by the passenger 2 himself or by a different passenger, as a numerical value into the communication device 4. It is provided, in particular, that the numerical value is entered via a keypad or rotary dial. In addition, it is conceivable for the passenger 2 to be given the facility in an intermediate step to perform a pre-categorization from individual lists. For example, one list relates to the gender and another list to different weight classes and, in the preselection undertaken in the intermediate step, the element most relevant to the passenger 2 is in each case selected. Following the input in the third method step, it is provided that the entered information is transmitted to the communication device 4, wirelessly or via a cable connection, to a control unit 5. It is also conceivable for the control unit 5 to be part of the communication device 4.

It is furthermore provided that the body height 3 received by the control unit 5 is used by the control unit 5 to determine a second vehicle seat configuration. It is provided here, in particular, that an algorithm based on simulations and/or empirical values is used to determine a second vehicle seat configuration adapted to the passenger 2. Along with the body height 3 as the single entered numerical value when determining the second vehicle seat configuration, it is conceivable for further information relating to the vehicle seat 1 or its environment and/or the pre-categorization undertaken in the intermediate step also to be taken into account. The further information relating to the vehicle seat 1 or its environment comprises, for example, details relating to the position of a steering wheel of the vehicle 6, the position of a wing mirror or a rearview mirror of the vehicle 6 and the position of an image area of a head-up display of the vehicle 6 relative to the vehicle seat. It is furthermore conceivable for a specific algorithm to be selected from a multitude of algorithms, wherein the specific algorithm is used in the fifth method step to determine the second vehicle seat configuration by means of the body height 3 as the single entered numerical value. It is also conceivable for the passenger 2 to be able to make an optional preselection in the intermediate step between different options relating to the driving style for the pre-adjustment of the vehicle seat. For example, the passenger 2 may opt for a “sport” or “economy” driving style and the corresponding pre-adjustment of the vehicle seat 1 is selected and adopted on the basis of the choice of the passenger 2. It is also conceivable for a start-up of the vehicle 6 not to be allowed in a safety mode, or for a warning signal to be emitted on start-up if the information, in particular the body height, is not entered into the communication device during the start-up or attempted start-up.

It is furthermore provided, in a sixth method step, that the vehicle seat is moved from the first vehicle seat configuration into a second vehicle seat configuration. An adjuster controlled by the control unit 5 and, in particular, motor-controlled, is preferably used which preferably communicates wirelessly or via cable with the control unit 5. The adjuster is preferably motor-controlled and manually actuatable. In a seventh method step, the vehicle seat 1 is then preferably moved manually by means of the adjuster or plurality of adjusters from a second vehicle seat configuration into a third vehicle seat configuration, whereby the passenger 2 is advantageously given the facility to make a fine adjustment by means of which the vehicle seat configuration can be adjusted according to his individual comfort requirements. For example, a length adjuster for adjusting a length position of the vehicle seat 1, a height adjuster for adjusting the vehicle seat 1, a backrest tilt adjuster, an armrest height adjuster, a seat area height adjuster, a seat area tilt adjuster, a headrest height adjuster and/or a headrest tilt adjuster are used as adjusters.

It is furthermore provided, in an eighth method step, that the third vehicle seat configuration is stored in a storage unit, in particular in a memory for vehicle seat configurations. The vehicle seat 1 can thereby be moved directly and without further effort from the first vehicle seat configuration into the third vehicle seat configuration when the information, in particular the numerical value, is re-entered into the communication device 4. However, it is also conceivable for the passenger 2 to be given a facility to select between the second and third vehicle seat configuration when the information is re-entered.

While specific embodiments of the invention have been shown and described in detail to illustrate the application of the principles of the invention, it will be understood that the invention may be embodied otherwise without departing from such principles.

1. A method for pre-adjusting a vehicle seat for a passenger using the vehicle seat, the method comprising:
providing the vehicle seat in a first vehicle seat configuration;
activating a communication device integrated into a vehicle that has the vehicle seat;
entering information relating to the passenger into the activated communication device;
transmitting the entered information to a control unit;
determining a second vehicle seat configuration depending on the transmitted information; and
moving the vehicle seat from the first vehicle seat configuration into the second vehicle seat configuration.

2. The method as claimed in claim 1, further comprising moving the vehicle seat manually or via further inputs into the communication device from the second vehicle seat configuration into a third vehicle seat configuration.

3. The method as claimed in claim 2, wherein the third vehicle seat configuration, preferably together with an ID, is stored in a storage unit, particularly in a memory for vehicle seat configurations.

4. The method as claimed in claim 1, wherein, the step of entering information comprises entering an individual numerical value describing the information into the communication device.

5. The method as claimed in claim 1, wherein an algorithm based on simulations and/or on empirical values is used to determine the second vehicle seat configuration.

6. The method as claimed in claim 1, wherein further information describing the vehicle seat or an environment thereof is used along with the information describing the passenger for determining the second vehicle seat configuration.

7. The method as claimed in claim 2, further comprising:
subsequent to the step of moving the vehicle seat manually or via further inputs into the communication device, re-entering the information describing the passenger;
moving the vehicle seat from the first vehicle seat configuration into the third vehicle seat configuration, and/or
offering the passenger a selection between the second vehicle seat configuration and the third vehicle seat configuration, whereby a pre-adjustment, comprising moving the vehicle seat from the first vehicle seat configuration into the second vehicle seat or a further movement from the second vehicle seat configuration into a third vehicle seat configuration is further simplified for the passenger to a movement of the vehicle seat directly to the selected second vehicle seat configuration or third vehicle seat configuration.

8. The method as claimed in claim 1, wherein the passenger is informed if a tolerance threshold for a deviation from the second vehicle seat configuration is exceeded.

9. The method as claimed in claim 2, wherein, in the movement from the second vehicle seat configuration into the third vehicle seat configuration, a modification of partial areas of the vehicle seat specific vehicle seat components, is not allowed.

10. The method as claimed in claim 2, further comprising a step in which a further component of the vehicle assumes a first component configuration or is moved into the first component configuration on the basis of the information entered into the communication device or the second or third vehicle configuration, wherein the adjustment of the further components is similarly individually adjustable by the passenger in a further method step.

11. The method as claimed in claim 1, wherein the step of moving the vehicle seat from the first vehicle seat configuration into the second vehicle seat configuration comprises an electrical adjustment of the vehicle seat can be stopped or paused or interrupted by means of an emergency shutdown functionality.

12. The method as claimed in claim 1, wherein the step of entering information relating to the passenger into the activated communication device occurs with the passenger seated in the vehicle for input into the communication device.

13. The method as claimed in claim 1, wherein the information describing the passenger is information relating to the body height of the passenger or relating to the body proportions of the passenger or relating to the preferred sitting position type.

14. The method as claimed in claim 1, wherein the vehicle seat and/or the environment of the vehicle is/are monitored by means of a sensor unit.

15. The method as claimed in claim 2, wherein a movement of the vehicle seat from the second vehicle seat configuration into the third vehicle seat configuration is controlled and/or adjusted with a weight transfer of the passenger during a predefined time window.

16. A device for pre-adjusting a vehicle seat for a passenger using the vehicle seat, the device comprising:
a communication device integrated into a vehicle, the communication device comprising a activating feature for activating the communication device and an input for an input of information describing the passenger into the activated communication device;
a control unit for receiving and further processing the information, the communication device having a communication connection with the control unit for transmitting input information to the control unit, the control unit being configured to, with an initial first vehicle seat configuration, determine a second vehicle seat configuration based on the transmitted information; and
an adjuster controllable by the control unit for adjusting a vehicle seat component to move the vehicle seat from the first vehicle seat configuration into the second vehicle seat configuration.

17. The device as claimed in claim 16, wherein the device has a storage unit for storing vehicle seat configurations.

18. The device as claimed in claim 17, wherein subsequent to the vehicle seat being moved from the first vehicle seat configuration into the second vehicle seat configuration subsequent manual movement or a further input into the communication device allows movement of the vehicle seat from the second vehicle seat configuration into a third vehicle seat configuration.

19. The device as claimed in claim 18, wherein the third vehicle seat configuration alone or with an ID, is stored in the storage unit, wherein the storage unit comprises a memory for vehicle seat configurations.

20. The device as claimed in claim 17 wherein the information is input as an individual numerical value describing the information.
